(19) United States
(12) Patent Application Publication
(10) Pub. No.: US 2011/0303458 A1
(43) Pub. Date: Dec. 15, 2011

(54) Coating of Non-Solderable Base Metal for Soldering Application in Medical Device Component

(75) Inventors: Todd C. Sutay, Warsaw, NY (US); Keith Seitz, Clarence Center, NY (US); Haytham Hussein, Orchard Park, NY (US); Sachin Thanawala, Lancaster, NY (US); Thomas Marzano, East Amherst, NY (US)

(73) Assignee: Greatbatch Ltd., Clarence, NY (US)

(21) Appl. No.: 13/160,540

(22) Filed: Jun. 15, 2011

Related U.S. Application Data
(60) Provisional application No. 61/354,747, filed on Jun. 15, 2010.

(51) Int. Cl. H02G 3/18; B05D 5/12; H01B 5/00

(52) U.S. Cl. 174/650; 174/126.2; 427/125; 427/123

(57) ABSTRACT

Terminal pins comprising a core of a first electrically conductive material selectively coated with a layer of a second electrically conductive material for incorporated into feedthrough filter capacitor assemblies are described. The feedthrough filter capacitor assemblies are particularly useful for incorporation into implantable medical devices such as cardiac pacemakers, cardioverter defibrillators, and the like, to decouple and shield internal electronic components of the medical device from undesirable electromagnetic interference (EMI) signals.

### CROSS-REFERENCE TO RELATED APPLICATIONS

This application claims priority from U.S. Provisional Patent Application Ser. No. 61/354,747 filed Jun. 15, 2010.

### BACKGROUND OF THE INVENTION

1. Field of the Invention

This invention relates generally to a hermetic feedthrough terminal pin, assembly, preferably of the type incorporating a filter capacitor. More specifically, this invention relates to terminal pins comprising a refractive metal core in which an electrically conductive second. metal is selectively coated to provide a cost effective terminal pin of increased solderability for incorporation into a feedthrough filter capacitor assembly, particularly of the type used in implantable medical devices such as cardiac pacemakers, cardioverter defibrillators, and the like, to decouple and shield internal electronic components of the medical device from undesirable electromagnetic interference (EMI) signals. The terminal pin feedthrough assembly provides a hermetic seal that prevents passage or leakage of fluids into the medical device.

2. Prior Art

Feedthrough assemblies are generally well known in the art for use in connecting electrical signals through the housing or case of an electronic instrument. For example, in an implantable medical device, such as a cardiac pacemaker, defibrillator, or neurostimulator, the feedthrough assembly comprises one or more conductive terminal pins supported by an insulator structure for passage of electrical signals from the exterior to the interior of the medical device. The conductive terminals are fixed into place using a gold brazing process, which provides a hermetic seal between the pin and insulative material. Conventionally, the terminal pins have been composed of platinum or combination of platinum and iridium. Platinum and platinum-iridium alloys are biocompatible, have good mechanical strength, which adds to the durability of the feedthrough. However, platinum is a precious metal that creates a manufacturing cost barrier.

The replacement of platinum and platinum alloys by refractive metals such as niobium, molybdenum and tungsten offers several advantages. First, these refractive metals have a significant cost advantage over platinum. Secondly, these refractive metals are generally known to be biocompatible. Finally, previous research has shown that after high temperature brazing, there is no significant degradation in the mechanical properties of these refractive metals, in comparison to platinum.

However, these refractive metals are susceptible to surface oxidation. Surface oxidation generally inhibits the ability of these metals to be joined to other materials, particularly other electrically conductive metals. What is needed, therefore, is a biocompatible, mechanically robust, cost effective terminal pin that can be readily joined to other metals. The present invention provides embodiments by which a terminal pin of a cost effective core metal is selectively coated with a metal that can be more readily joined to other electrically conductive metals.

### SUMMARY OF THE INVENTION

In a preferred form, a feedthrough filter capacitor assembly according to the present invention comprises an outer ferrule hermetically sealed to either an alumina insulator or fused glass dielectric material seated within the ferrule. The insulative material is also hermetically sealed to at least one terminal pin. That way, the feedthrough assembly prevents leakage of fluid, such as body fluid in a human implant application, past the hermetic seal at the insulator/ferrule and insulator/terminal pin interfaces.

According to the invention, the terminal pin of a feedthrough assembly, and preferably of a feedthrough filter capacitor assembly, is composed of a refractive metal core in which a layer of a non-refractive electrically conductive second metal is selectively contacted to the surface of the pin core. In a preferred embodiment, the terminal pin comprises a core of tantalum, niobium, molybdenum or alloy thereof. A layer of a second non-refractive electrically conductive metal, such as palladium, platinum, gold or silver, is selectively applied to a portion or portions of the surface of the core metal. In that respect, the application of the second electrically conductive metal is an alternative solderable, oxidation resistant material that provides a considerably less expensive terminal pin than conventional platinum or platinum-iridium terminal pins while still achieving the same benefits of biocompatibility, good mechanical strength, solderability and a reliable hermetic feedthrough seal.

These and other objects and advantages of the present invention will become increasingly more apparent by a reading of the following description in conjunction with the appended drawings.

### BRIEF DESCRIPTION OF THE DRAWINGS

FIG. 1 is a perspective view of a feedthrough assembly embodying the novel features of the present invention.

FIG. 2 is cross-sectional view of the feedthrough assembly of the present invention taken along line 2-2 of FIG. 1.

FIG. 3 is a side view of a preferred embodiment of a selectively coated terminal pin.

FIG. 4 is a cross-sectional view of a coated portion of the terminal pin taken along line 4-4 of FIG. 3.

FIG. 5 is a cross-sectional view of the feedthrough assembly of the present invention taken along line 5-5 of FIG. 2.

FIG. 6 is a cross-sectional view of the feedthrough assembly taken along line 6-6 of FIG. 2.

### DETAILED DESCRIPTION OF THE PREFERRED EMBODIMENTS

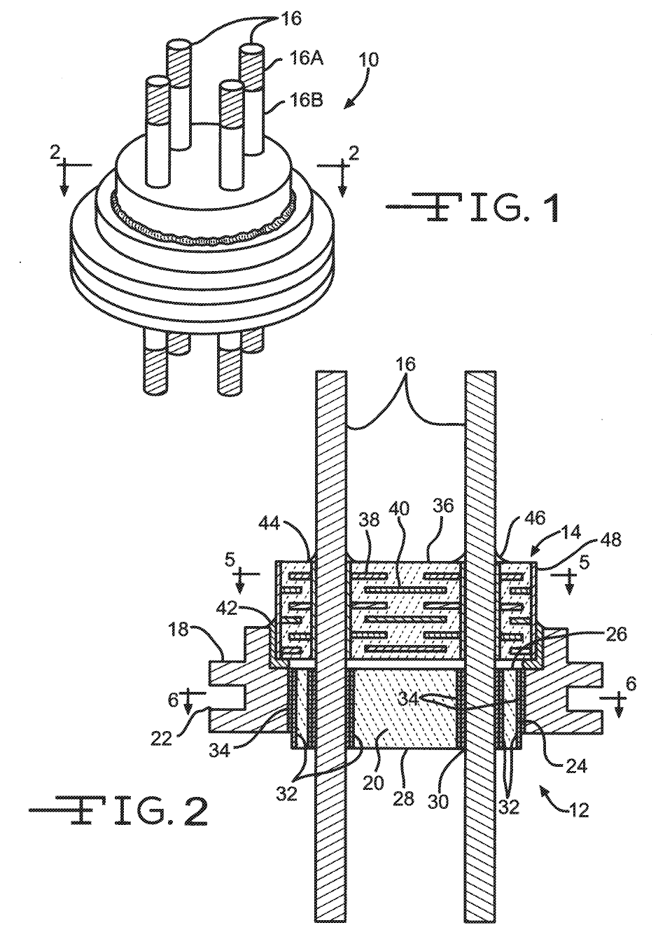

Referring now to the drawings, FIGS. 1 and 2 show an internally grounded feedthrough capacitor assembly 10 comprising a feedthrough 12 supporting a filter discoidal capacitor 14. The feedthrough filter assembly 10 is useful with medical devices, preferably implantable devices such as pacemakers, cardiac defibrillators, cardioverter defibrillators, cochlear implants, neurostimulators, internal drug pumps, deep brain stimulators, hearing assist devices, incontinence devices, obesity treatment devices, Parkinson's disease therapy devices, bone growth stimulators, and the like. The feedthrough 12 portion of the assembly 10 includes terminal pins 16 that provide for coupling, transmitting and receiving electrical signals to and from a patient's heart, while hermetically sealing the interior of the medical instrument against ingress of patient body fluids that could otherwise disrupt instrument operation or cause instrument malfunction. While not necessary for accomplishing these functions, it is desirable to attach the filter capacitor 14 to the feedthrough 12 for suppressing or decoupling undesirable EMI signals and noise transmission into the interior of the medical device.

More particularly, the feedthrough 12 of the feedthrough filter capacitor assembly 10 comprises a ferrule 18 defining an insulator-receiving bore surrounding an insulator 20. Suitable electrically conductive materials for the ferrule 18 include titanium, tantalum, niobium, stainless steel or combinations of alloys thereof, the former being preferred. The ferrule 18 may be of any geometry, non-limiting examples being round, rectangle, and oblong. A surrounding flange 22 extends from the ferrule 18 to facilitate attachment of the feedthrough 12 to the casing (not shown) of, for example, one of the previously described implantable medical devices. The method of attachment may be by laser welding or other suitable methods.

The insulator 20 is of a ceramic material such as of alumina, zirconia, zirconia toughened alumina, aluminum nitride, boron nitride, silicon carbide, glass or combinations thereof. Preferably, the insulating material is alumina, which is highly purified aluminum oxide, and comprises a sidewall 24 extending to a first upper side 26 and a second lower side 28. The insulator 20 is also provided with bores 30 that receive the terminal pins 16 passing there through. A layer of metal 32, referred to as metallization, is applied to the insulator sidewall 24 and the sidewall of the terminal pin bores 30 to aid a braze material 34 in hermetically sealing between the ferrule 18 and the insulator 20 and between the terminal pins 16 and the insulator 20, respectively.

Suitable metallization materials 32 include titanium, titanium nitride, titanium carbide, iridium, iridium oxide, niobium, tantalum, tantalum oxide, ruthenium, ruthenium oxide, zirconium, gold, palladium, molybdenum, silver, platinum, copper, carbon, carbon nitride, and combinations thereof. The metallization layer may be applied by various means including, but not limited to, sputtering, electron-beam deposition, pulsed laser deposition, plating, electroless plating, chemical vapor deposition, vacuum evaporation, thick film application methods, and aerosol spray deposition, and thin cladding.

Non-limiting examples of braze materials include gold, gold alloys, and silver. Then, if the feedthrough 12 is used where it will contact bodily fluids, the resulting brazes do not need to be covered with a biocompatible coating material. In other embodiments, if the brazes are riot biocompatible, for example, if they contain copper, they are coated with a layer/coating of biocompatible/biostable material. Broadly, the biocompatibility requirement is met if contact of the braze/coating with body tissue and blood results in little or no immune response from the body, especially thrombogenicity (clotting) and encapsulation of the electrode with fibrotic tissue. The biostability requirement means that the braze/coating remains physically, electrically, and chemically constant and unchanged over the life of the patient.

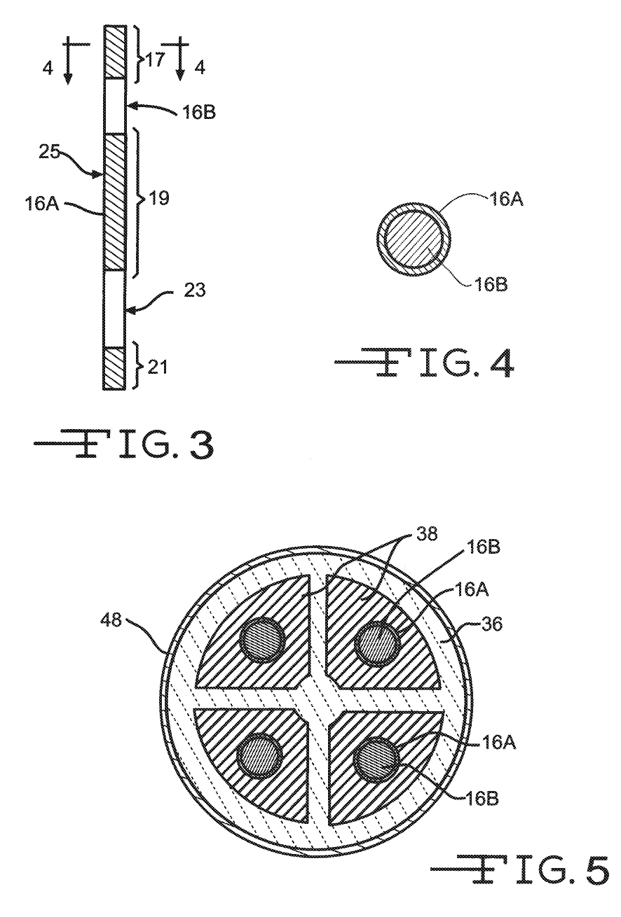

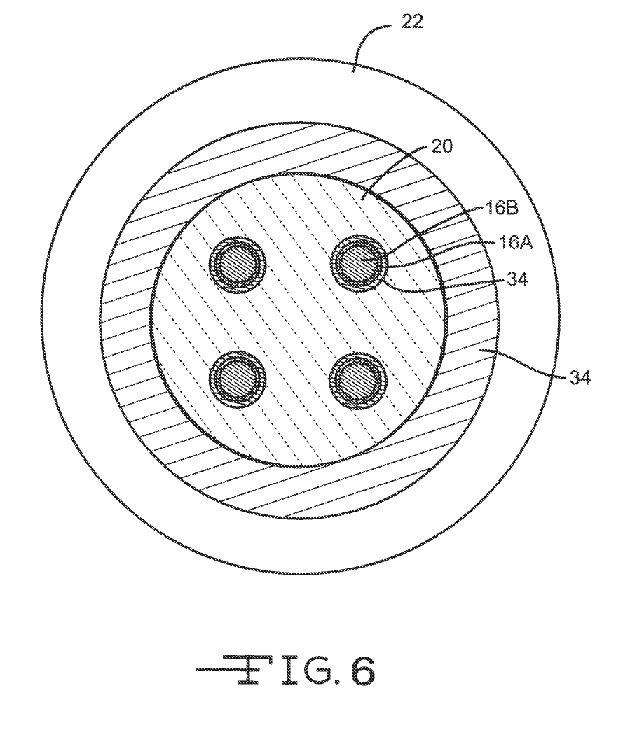

In an embodiment of the present invention, the terminal pins 16 (FIGS. 3, 4, 5 and 6) comprise a terminal pin core 16B of a first electrically conductive material and an exterior outer coating 16A of a second electrically conductive material. In a more preferred embodiment of the invention, the terminal pins 16 comprise a core 168 of a refractive metal and an exterior outer coating 16A comprising palladium and its alloys. Non-limiting examples include pure palladium and alloys comprising from about 50% to about 99% palladium along with other elements including those from the platinum group such as ruthenium, rhenium, and iridium, or refractory metals such as molybdenum, and boron, and combinations thereof.

Mechanical properties of the terminal pin 16 can be tailored to a desired mechanical performance by adjusting the amounts of the elemental additions in the palladium alloy. For example, age hardening can be improved by increasing the amount of ruthenium. Other additions to the palladium alloy such as platinum, gold, copper, and zinc, for example, increase the alloy's ability to achieve a higher tensile strength.

As previously mentioned, the terminal pin core 16B is comprised of a refractive metal. A refractory metal is herein defined as a metal that is resistant to heating and has a melting temperature greater than about 1,800° C. Non-limiting examples of refractory metals include niobium, molybdenum, tantalum, tungsten, rhenium, titanium, vanadium, zirconium, hafnium, osmium, iridium, and alloys thereof. In a more preferred embodiment, the terminal pin core 16B comprises niobium and niobium alloys. However, an alternative embodiment, the terminal pin core 168 may comprise nickel-titanium (NITINOL®, titanium, particularly beta titanium, titanium alloys, stainless steel, palladium and palladium alloys, and combinations thereof.

In a preferred embodiment, the external outer coating 16A comprises an alternative electrically conductive metal. Non-limiting examples of this alternative second conductive metal comprise platinum, gold, silver, nickel and combinations thereof.

In a preferred embodiment, this second electrically conductive metal may have a surface 25 that is readily joinable to other materials, particularly electrically conductive metals. These material-joining processes may include soldering, welding and/or brazing. Preferably, the surface 25 of the second metal is “wettable” to tin based solders, such as Sn63/Pb37 and the like. A “wettable” surface is herein defined as the ability of a material to adhere to the surface.

In a preferred embodiment, as shown in FIGS. 1, 3 and 4, the external outer coating 16A of the second electrically conductive metal is selectively applied at discrete locations to a surface 23 of the terminal pin core 16B. Preferably the external outer coating 16A of the second electrically conductive metal is applied to a discrete portion or portions of the surface 23 of the terminal pin core 16B. These portions may include but are not limited to a distal end portion 21, a central portion 19 and/or a proximal end portion 17 of the terminal pin core 16B.

The means of coating may include sputtering, cladding, and or plating. The coating may be applied through a process of sputtering, electron-beam deposition, pulsed laser deposition, plating, electroless plating, chemical vapor deposition, vacuum evaporation, thick film application methods, aerosol spray deposition, and thin cladding.

Such a preferred embodiment of selectively applying the exterior outer coating 16A enhances electrical conduction and retards oxidation of the surface 23 of the terminal, pin core 16B within these regions 17, 19, 21. Selectively applying the external outer coating 16A to the core 16B allows for improved design and manufacturing flexibility. For example, the coating 16A may be precisely applied to the surface 23 of the core 16B after high temperature processing. This feature is beneficial the external outer coating 16A can be tailored to meet the dimensions of the joining metal. Furthermore, the application of the external outer coating 16A to a discrete portion of the core 16B further reduces cost of manufacture.

In a preferred embodiment, as illustrated in FIGS. 1, 3, the portions 17,19,21 of the external outer coating 16A may not be limited to a single external outer coating 16A composition. For example, the proximal end portion 17 of the terminal pin core 16B may be coated with a metal that is of a composition that is different then the coating 16A comprising the distal end portion 21 and/or the central. portion 19. This feature of designing an external outer coating 16A of multiple compositions allows for custom tailoring of electrical or joining properties. The proximal and distal end portions 17, 21, each have a length of about 5 percent to about 15 percent of the total length of the terminal pin 16 may be coated with an outer external coating 16A of composition “A” which is preferable for soldering. The central portion 19 of the terminal pin core 16B, located within the capacitor 14, and having a length of from about 10 percent to about 40 percent of the total length of the terminal pin 16, may be coated with composition “B” which is readily joined to the metallization material by soldering, and the like, to provide improved electrical conduction or EMI filtration performance.

For example, it is known that refractive metals such as niobium, tungsten and molybdenum readily oxidize. This means that when it is used as a terminal pin material, secondary operations are necessary in order to effect a hermetic braze with low equivalent series resistance (ESR) characteristics. Providing a palladium outer coating 16A over a niobium core 16B in an evacuated atmosphere prior to formation of niobium oxide ensures that the thusly constructed terminal pin can be directly brazed into the insulator 20.

Although the terminal pin 16 is shown having a circular cross-section, that is not necessary. The terminal pin. 16 can have other cross-sectional shapes including square, triangular, rectangular, and hexagonal, among others. Nonetheless, the core 16B has a diameter of from about 0.002 inches to about 0.020 inches and the outer coating 16A has a thickness of from about 0.5μ inches to about 0.002 inches.

Up to now, terminal pins for feedthrough assemblies used in implantable medical devices, and the like, have generally consisted of platinum. However, replacement of platinum and platinum alloys by such alternative metals as palladium and its alloys offers several advantages. For one, the density of platinum is 21.45 g/cc in comparison to palladium at 12.02 g/cc. Both of these materials are priced by weight, but used by volume. Therefore, palladium has significant cost advantage over platinum. Secondly, palladium has comparable electrical conductivity to platinum (platinum=94.34 l/mohm-cm, palladium=94.8 l/mohm-cm and gold=446.4 l/mohm-cm). Thirdly, palladium and platinum have significantly equivalent mechanical properties. After high temperature brazing, there is no significant degradation of mechanical properties such as strength and elongation. Fourthly, palladium is both solderable and weldable. Fifthly, palladium has good radiopacity characteristics. This is an important consideration for viewing the terminal pin during diagnostic scans such as fluoroscopy. Lastly, but every bit as important, palladium is biocompatible. Previous research indicates a variety of positive biocompatibility studies (both soft tissue and bone) for all elements used. Palladium and its alloy additives are regarded as chemically inactive.

As further shown in FIGS. 1 and 3, the feedthrough filter capacitor 10 includes the filter capacitor 14 that provides for filtering undesirable EMI signals before they can enter the device housing via the terminal pins 16. The filter capacitor 14 comprises a ceramic or ceramic-based dielectric monolith 36 having multiple capacitor-forming conductive electrode plates formed therein. The capacitor dielectric 36 preferably has a circular cross-section matching the cross-section of the ferrule 18 and supports a plurality of spaced-apart layers of first or “active” electrode plates 38 in spaced relationship with a plurality of spaced apart layers of second or “ground” electrode plates 40. The filter capacitor 14 is preferably joined to the feedthrough 12 adjacent to the insulator side 26 by an annular bead 42 of conductive material, such as a solder or braze ring, or a thermal-setting conductive adhesive, and the like. The dielectric 36 includes lead bores 44 provided with an inner surface metallization layer. The terminal pins 16 pass there through and are conductively coupled to the active plates 38 by a conductive braze material 46 contacting between the terminal pins 16 and the bore metallization. In a similar manner, the ground plates 40 are electrically connected through an outer surface metallization 48 and the conductive material 42 to the ferrule 18.

It is appreciated that various modifications to the invention concepts described herein may be apparent to those of ordinary skill in the art without departing from the scope of the present invention as defined by the appended claims.

What is claimed is:

1. A feedthrough assembly, which comprises:
a) an insulator of electrically non-conductive material having a height defined by an insulator sidewall extending to a first insulator end and a second insulator end, wherein the insulator has at least one terminal pin bore extending from the first end to the second end thereof;
b) a terminal pin received in the terminal pin bore, the terminal pin having a sidewall extending to opposed first and second ends disposed spaced from the respective first and second insulator ends, wherein the terminal pin comprises a terminal pin core of a first electrically conductive material and an external outer coating of a second electrically conductive material supported on a portion or portions of the terminal pin core;
c) a ferrule of an electrically conductive material and comprising a ferrule opening defined by a surrounding sidewall extending to a first ferrule end and a second ferrule end, wherein the insulator is supported in the ferrule opening; and
d) a first braze material contacting the coating of the second electrically conductive material on the terminal pin core thereby hermetically sealing the terminal pin to the insulator and a second braze material hermetically sealing the insulator to the ferrule.

2. The feedthrough assembly of claim 1 wherein the first electrically conductive material of the terminal pin core is selected from the group consisting of niobium, tantalum, nickel-titanium, titanium, particularly beta titanium, titanium alloys, stainless steel, molybdenum, tungsten, platinum, and combinations thereof.

3. The feedthrough assembly of claim I wherein the first electrically conductive material is left uncovered by the external outer coating where the second electrically material is not present.

4. The feedthrough assembly of claim 1 wherein the coated portion of the terminal pin comprises a proximal end portion, a distal end portion and/or a center portion.

5. The feedthrough assembly of claim 4 wherein the second electrically conductive material contacts from about 5 percent to about 15 percent of a total length of the terminal pin where it resides, at least one portion residing at either the proximal or distal end of the terminal pin.

6. The feedthrough assembly of claim 1 wherein the second electrically conductive material contacts from about 10 percent to about 40 percent of a total length of the terminal pin where it is hermetically sealed to the insulator.

7. The feedthrough assembly of claim 4 wherein the second electrically conductive material, contacting the proximal portion is of a different composition than that of the second electrically conductive material contacting the distal or central portion of the terminal pin.

8. The feedthrough assembly of claim I wherein the terminal pin core has a diameter of from about 0.002 inches to about 0.020 inches.

9. The feedthrough assembly of claim 1 wherein the second electrically conductive material is a metal selected from the group consisting of palladium, palladium alloys, platinum, gold, silver, nickel and combinations thereof.

10. The feedthrough assembly of claim 9 wherein the palladium alloy includes at least one alloy material selected from the group consisting of ruthenium, rhenium, iridium, molybdenum, boron.

11. The feedthrough assembly of claim 1 wherein the external outer coating of the second electrically conductive material the terminal pin has a thickness of from about 0.5μ inches to about 0.003 inches.

12. The feedthrough assembly of claim 1 wherein the terminal pin has a cross-sectional shape selected from the group consisting of circular, square, rectangular, and hexagonal.

13. The feedthrough assembly of claim 1 wherein the insulator is selected from the group consisting of alumina, zirconia, zirconia toughened alumina, aluminum nitride, boron nitride, silicon carbide, glass, and mixtures thereof.

14. The feedthrough assembly of claim 1 wherein the electrically conductive material of the ferrule is selected from the group consisting of titanium, tantalum, niobium, stainless steel, and combinations of alloys thereof.

15. The feedthrough assembly of claim 1 wherein the first and second braze materials are selected from the group consisting of gold, gold alloys, and silver.

16. The feedthrough assembly of claim 1 further including a metallization material covering the insulator sidewall and the terminal pin bore, the metallization material selected from the group consisting of titanium, titanium nitride, titanium carbide, iridium, iridium oxide, niobium, tantalum, tantalum oxide, ruthenium, ruthenium oxide, zirconium, gold, palladium, molybdenum, silver, platinum, copper, carbon, carbon nitride, and mixtures thereof.

17. A terminal pin for incorporation into a feedthrough, the terminal pin comprising:
a) a terminal pin core of a first electrically conductive material; and
b) an external outer coating of a second electrically conductive material supported on a portion of the terminal pin core to a thickness such that the second electrically conductive material is not completely diffused into the first electrically conductive material of the terminal pin core.

18. The terminal pin of claim 17 wherein first electrically conductive material of the terminal pin core is selected from the group consisting of niobium, tantalum, NITINOL, titanium, particularly beta titanium, titanium alloys, stainless steel, molybdenum, tungsten, platinum, and combinations thereof.

19. The terminal pin of claim 17 wherein the terminal pin core has a diameter of from about 0.002μ inches to about 0.020 inches.

20. The terminal pin of claim 17 wherein the outer coating of the second electrically conductive material is a metal selected from the group consisting of palladium, palladium alloys, gold, silver, nickel, platinum and combinations thereof.

21. The terminal pin of claim 20 wherein the palladium alloy includes at least one alloy material selected from the group consisting of ruthenium, rhenium, iridium, molybdenum, boron.

22. The terminal pin of claim 17 wherein the outer layer of the second electrically conductive material for the terminal pin has a thickness of from about 0.5μ inches to about 0.002 inches.

23. The terminal pin of claim 17 wherein the coated portion of the terminal, pin comprises a proximal portion, a center portion and/or a distal portion.

24. A method for providing a terminal pin for incorporation into a feedthrough assembly, comprising the steps of:
a) providing a terminal pin core of a first electrically conductive material; and
b) coating portion of the terminal pin core with an outer layer of a second electrically conductive material to a thickness such that the second electrically conductive material is not completely diffused into the first electrically conductive material of the terminal pin core.

25. The method of claim 24 including coating the second electrically conductive over the terminal pin core using a process selected from the group consisting of sputtering, electron-beam deposition, pulsed laser deposition, plating, electroless plating, chemical vapor deposition, vacuum evaporation, thick film application methods, aerosol spray deposition, and thin cladding.

26. The method of claim 24 including selecting the first electrically conductive material of the terminal pin core from the group consisting of niobium, tantalum, nickel titanium, titanium, particularly beta titanium, titanium alloys, stainless steel, molybdenum, tungsten, platinum, and combinations thereof.

27. The method of claim 24 including providing the terminal pin core having a diameter of from about 0.002 inches to about 0.020 inches.

28. The method of claim 24 including providing the outer coating of the second electrically conductive material being selected from the group consisting of palladium, palladium alloys, gold, silver, nickel, platinum, and combinations thereof.

29. The method of claim 28 including providing the palladium alloy including at least one alloy material selected from the group consisting of ruthenium, rhenium, iridium, molybdenum, boron.

30. The method of claim 24 including providing the outer coating of the second electrically conductive material for the terminal pin having a thickness of from about 0.5μ inches to about 0.003 inches.
